(19) United States
(12) Patent Application Publication
(10) Pub. No.: US 2026/0359022 A1
(43) Pub. Date: Nov. 12, 2026

(54) CODE GENERATION METHOD, APPARATUS, ELECTRONIC DEVICE, STORAGE MEDIUM, AND PROGRAM PRODUCT

(71) Applicants: Beijing Volcano Engine Technology Co., Ltd., Beijing (CN); Bytedance Technology Ltd., Grand Cayman (KY)

(72) Inventors: Yang SUN, Beijing (CN); Han WENG, Beijing (CN); Boyi LIU, Beijing (CN); Yi ZHAN, Beijing (CN); Longjie CUI, Beijing (CN); Xiaoming YIN, Beijing (CN)

(21) Appl. No.: 19/670,643

(22) Filed: May 7, 2026

(30) Foreign Application Priority Data
May 7, 2025 (CN) 202510583432.8

(51) Int. Cl. G06F 8/35; G06V 30/19

(52) U.S. Cl. CPC G06F 8/35; G06V 30/19067

(57) ABSTRACT

The present application discloses a code generation method and apparatus, an electronic device, a storage medium, and a program product, which relate to the field of computer technologies. The method includes: acquiring a first relational operation tree corresponding to a reference code statement and a second relational operation tree corresponding to a predicted code statement; performing structural matching of code statements for the first relational operation tree and the second relational operation tree in a graph matching manner to determine a structural matching result; and guiding a code generation process of a code generation model based on the structural matching result to obtain a target code matching code generation prompt information.

### CROSS-REFERENCE TO RELATED APPLICATIONS

The present application is based on and claims priority to Chinese Patent Application No. 202510583432.8, and filed on May 7, 2025, the entire disclosure of the Chinese Patent Application is hereby incorporated by reference in its entirety.

### TECHNICAL FIELD

The present disclosure relates to the field of computer technologies, and in particular, to a code generation method, an apparatus, an electronic device, a storage medium, and a program product.

### BACKGROUND

With the significant breakthrough in the development of large language models (LLM), the application of LLM in the field of natural language processing (NLP) has gradually expanded, showing great potential in code generation tasks. Therefore, special-purpose code LLMs for specific programming tasks have been developed to take advantage of language characteristics and task requirements in specific domains to improve the accuracy and reliability of code generation.

### SUMMARY

In view of this, the present disclosure provides a code generation method, an apparatus, an electronic device, a storage medium, and a program product.

In a first aspect, the present disclosure provides a code generation method, including: acquiring a first relational operation tree corresponding to a reference code statement and a second relational operation tree corresponding to a predicted code statement, where the predicted code statement is generated by a pre-trained code generation model according to code generation prompt information, and the reference code statement corresponds to the predicted code statement; performing structural matching of code statements for the first relational operation tree and the second relational operation tree in a graph matching manner to determine a structural matching result; and guiding a code generation process of the code generation model based on the structural matching result to obtain a target code matching the code generation prompt information.

In a second aspect, the present disclosure provides a code generation apparatus, including: an operation tree acquisition module configured to acquire a first relational operation tree corresponding to a reference code statement and a second relational operation tree corresponding to a predicted code statement, where the predicted code statement is generated by a pre-trained code generation model according to code generation prompt information, and the reference code statement corresponds to the predicted code statement; a structural matching module configured to perform structural matching of code statements for the first relational operation tree and the second relational operation tree in a graph matching manner to determine a structural matching result; and a generation module configured to guide a code generation process of the code generation model based on the structural matching result to obtain a target code matching the code generation prompt information.

In a third aspect, the present disclosure provides an electronic device, including: a memory and a processor, where the memory and the processor are communicatively connected to each other, the memory stores computer instructions, and the processor executes the computer instructions to perform the code generation method according to the first aspect or any implementation corresponding thereto.

In a fourth aspect, the present disclosure provides a computer-readable storage medium having computer instructions stored thereon, where the computer instructions are used to cause a computer to perform the code generation method according to the first aspect or any implementation corresponding thereto.

In a fifth aspect, the present disclosure provides a computer program product including computer instructions, where the computer instructions are used to cause a computer to perform the code generation method according to the first aspect or any implementation corresponding thereto.

### BRIEF DESCRIPTION OF THE DRAWINGS

In order to more clearly illustrate the technical solutions in the specific embodiments of the present disclosure or in the related art, the following briefly introduces the drawings that need to be used in the description of the specific embodiments or the related art. Obviously, the drawings in the following description are some embodiments of the present disclosure, and for those ordinary skilled in the art, other drawings may also be derived from these drawings without creative efforts.

FIG. 1 is a schematic diagram of an application scenario according to an embodiment of the present disclosure;

FIG. 2 is a schematic flowchart of a code generation method according to an embodiment of the present disclosure;

FIG. 3 is a schematic flowchart of another code generation method according to an embodiment of the present disclosure;

FIG. 4 is a schematic diagram of structural matching in a manner of rule-based matching according to an embodiment of the present disclosure;

FIG. 5 is a schematic diagram of structural matching based on a graph matching neural network according to an embodiment of the present disclosure;

FIG. 6 is a schematic flowchart of yet another code generation method according to an embodiment of the present disclosure;

FIG. 7 is a schematic diagram of optimization of a code generation model according to an embodiment of the present disclosure;

FIG. 8 is a structural block diagram of a code generation apparatus according to an embodiment of the present disclosure; and

FIG. 9 is a schematic hardware structural diagram of an electronic device according to an embodiment of the present disclosure.

### DETAILED DESCRIPTION OF EMBODIMENTS

In order to make the objectives, technical solutions, and advantages of embodiments of the present disclosure clearer, the technical solutions in the embodiments of the present disclosure will be described clearly and comprehensively with reference to the drawings in the embodiments of the present disclosure. Obviously, the described embodiments are part of the embodiments of the present disclosure, rather than all of them. All other embodiments obtained by those skilled in the art based on the embodiments of the present disclosure without creative efforts shall fall within the protection scope of the present disclosure.

It may be understood that before using the technical solutions disclosed in the embodiments of the present disclosure, the user shall be informed of the type, range of use, use scenarios, etc., of personal information involved in the present disclosure and obtain the authorization of the user in an appropriate manner in accordance with relevant laws and regulations.

For example, in response to receiving an active request from a user, prompt information is sent to the user to clearly inform the user that the requested operation will require access to and use of the user's personal information. In this way, the user may independently choose whether to provide personal information to software or hardware, such as an electronic device, an application, a server, or a storage medium, that performs the operations of the technical solutions of the present disclosure based on the prompt information.

As an optional but non-limiting implementation, in response to receiving an active request from a user, the prompt information may be sent to the user in the form of, for example, a pop-up window, in which the prompt information may be presented in text. In addition, the pop-up window may also include a selection control for the user to choose whether to “agree” or “disagree” to provide personal information to the electronic device.

It may be understood that the above process of notifying and obtaining user authorization is only illustrative and does not limit the implementations of the present disclosure, and other methods that meet relevant laws and regulations may also be applied to the implementations of the present disclosure.

It may be understood that the data involved in the technical solution (including but not limited to the data itself, acquisition or use of the data) shall comply with the requirements of corresponding laws, regulations and related provisions.

In recent years, thanks to the optimization of model architectures, the progress of training methods, and the availability of large-scale datasets, the development of large language models (LLM) has made significant breakthroughs. With the emergence of models such as GPT and BERT, the application of LLM in the field of natural language processing (NLP) has gradually expanded, showing great potential in code generation tasks.

At present, general code generation models have received extensive attention because they may reduce the threshold of writing code through automated programming, and special-purpose code LLMs for specific programming tasks are also developing to take advantage of language characteristics and task requirements in specific domains to improve the accuracy and reliability of code generation.

In code generation tasks, as a key direction for automated code generation, text-to-SQL is dedicated to narrowing the gap between natural language and structured query language (SQL). The text-to-SQL code generation model allows users (especially users without a technical background) to interact with databases through natural language, thereby playing a key role in data-driven decision making. With the code generation model trained based on the large language model being applied to text-to-SQL tasks, it is crucial to output SQL code statements that better meet user expectations.

The code generation model obtained by training based on the large language model architecture is applied to the text-to-SQL code generation task, and important progress has been made in terms of the accuracy of database query generation. In order to ensure that the code generation model may output results that better meet user expectations, fine-tuning techniques are usually used for model fine-tuning, and reinforcement learning (RL) and reinforcement learning from human feedback (RLHF) are one of the cores of the development of large language models. Among them, RLHF fine-tunes the code generation model by introducing human feedback; reinforcement learning optimizes the model through execution feedback, so that the generated codes are not only grammatically correct, but also functionally as expected. Execution feedback usually evaluates the quality of the generated codes by running them and checking their output or behavior, thereby promoting the performance improvement of the code generation model in code generation tasks.

Although the code generation model optimized by reinforcement learning shows good results, the dependence on execution feedback brings many challenges, including: (1) high cost of data annotation. Execution feedback requires the construction of high-quality unit tests, and the writing and maintenance of unit tests require a lot of manpower and time. (2) limited scalability. Since execution feedback depends on a real code execution environment, its application on large-scale and diverse datasets is limited. (3) particularity of text-to-SQL code generation tasks. In text-to-SQL code generation tasks, unit tests not only need to verify the correctness of queries, but also need to design databases to cover boundary situations and distinguish subtle differences between different query methods. Therefore, the construction of unit tests for the text-to-SQL tasks is more complicated than that for general code generation tasks.

In view of the above problems, although there are some model-based reward mechanisms to replace execution feedback, for example, the reward signal generated by LLM is used to guide code optimization, in code generation tasks, it is difficult for the model-based reward to maintain stability and generalization ability in the post-training stage of reinforcement learning.

Based on this, the technical solution of the present disclosure aims to break through the limitations in the related art and introduce a reward mechanism based on a graph matching network (GMN) to replace the execution feedback in code generation tasks. Compared with the reward signal predicted based on the LLM, the technical solution of the present disclosure uses the structural information of SQL queries, treats SQL queries as graph structure data, and compares them through the graph matching network to evaluate the similarity between queries. Since the GMN has a low computational complexity, it requires less computational resources in the training and deployment phases than the predicting reward signals based on the LLM. Since the GMN directly models the structure of SQL statements instead of relying on the reward signal predicted by the LLM, its generalization and stability are better than the LLM-based reward method.

Specifically, most code generation models based on reinforcement learning (RL) rely on execution feedback for optimization, that is, by running the generated codes and calculating rewards based on the execution results. However, this method requires high-quality unit tests, and the cost of constructing and maintaining unit tests is extremely high. Especially in text-to-SQL code generation tasks, the requirements for database design and test coverage are higher, which further increases the cost of data annotation and maintenance. In addition, the maintenance of a real execution environment requires a large amount of computing resources, making it difficult to apply this method on a large scale.

The present disclosure performs evaluation by using the structural information of SQL queries, instead of relying on database execution results. This method converts SQL statements into relational operation trees (ROTs), and uses graph matching techniques to calculate the structural similarity between a generated SQL and a reference SQL, thereby providing a reliable reward signal. This method eliminates the dependence on costly execution feedback and greatly reduces the training and deployment costs.

Since execution feedback depends on the availability of a real database, the methods in the related art have limited generalization ability in different tasks or different database environments. For example, in large industrial applications, it is unrealistic to build a test database for each new task. In addition, the content of the database may change, which affects the execution result of SQL statements, leading to instability of the reward signal, and making it difficult for the model to work stably in different database environments.

In the technical solution of the present disclosure, the GMN analyzes the structural characteristics of SQL statements, rather than specific data execution results, so that the calculation of the reward signal does not depend on a specific database. This method enhances the generalization ability of the model, enabling it to maintain stable performances in different database environments. In addition, the GMN may also capture the deep semantic relationship of SQL statements, so that the model does not need to rebuild unit tests when migrating to a new task or a new database, thereby improving the scalability of the model.

In the related art, the reward model predicted based on the LLM has instability, is greatly affected by training data deviation, and it is difficult to provide a consistent reward signal. In addition, the execution feedback method depends on the execution results of the SQL statements, but functionally equivalent SQL statements may produce different execution results due to different query optimization policies, resulting in inaccuracy of the reward signal.

The present disclosure uses GMN to calculate the similarity of SQL structures, and ensures that functionally equivalent SQL statements can obtain the same reward signal through the graph matching method, thereby avoiding the deviation of predicted rewards and the limitations of the execution feedback method.

As an optional application scenario of an embodiment of the present disclosure, as shown in FIG. 1, the application scenario includes a code generation model 101 that is trained based on a large language model architecture, and an electronic device 102. In FIG. 1, only a limited number of components and exemplary connection relationships are shown. It should be understood that this is for the convenience of description and illustration, and is not intended to limit the scope of the present disclosure, and there may be other different components, for example, a display component and an input component, etc. By way of example rather than limitation, a diagnosis result of a target page may be displayed on the display component, and a problem description and a problem type may be adjusted through the input component.

According to an embodiment of the present disclosure, the user may input a data query intention through an interactive interface provided by the electronic device 102, and the code generation model 101 may convert the data query intention into a corresponding target code, thereby lowering the technical threshold of the user for code writing and realizing automated code generation.

The code generation model 101 can be deployed in the electronic device 102, and the electronic device 102 represents a device that has computing resources or computing power and may have computing power. For example, the electronic device may be provided with a processor, a memory, etc., and may also be equipped with a dedicated accelerator (such as a graphics processing unit (GPU), etc.). In addition, the electronic device may store and maintain data.

Examples of the electronic device 102 may include a supercomputer, a personal computer, a laptop computer, an in-vehicle computing device, a mobile device (such as a smartphone, a tablet computer, etc.), or a combination including any one or more of the above devices, etc. It should be understood that the computer device described herein is only exemplary and non-limiting, and for example, other different types of computer devices may also be used.

In some embodiments, there provides a code generation method, an apparatus, an electronic device, a storage medium, and a program product, which will be described hereinafter, so as to solve at least one of technical problems, including, for example, at least one of the problems discussed herein, a problem of poor accuracy in generating code statements.

According to embodiments of the present disclosure, an embodiment of a code generation method is provided. It should be noted that the steps shown in the flowchart of the drawings may be executed in a computer system such as a group of computer executable instructions, and although the logical order is shown in the flowchart, in some cases, the steps shown or described may be executed in an order different from that here.

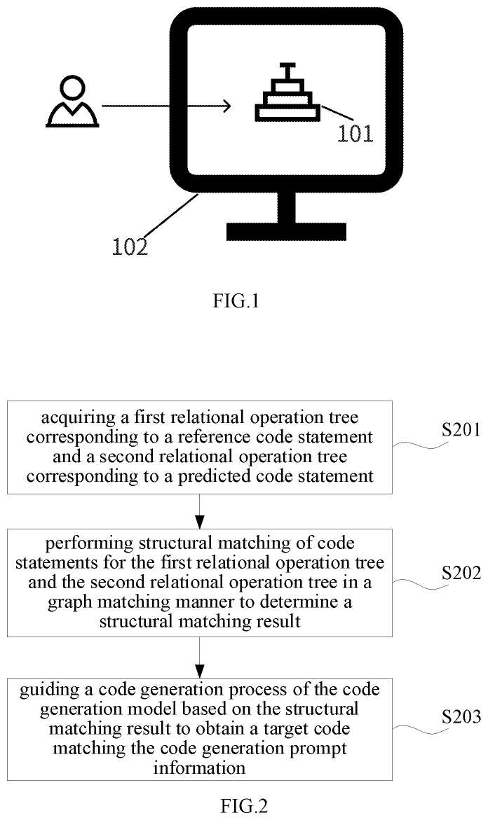

In the embodiment, a code generation method is provided, which may be applied to an electronic device, such as a computer, a tablet computer, etc. FIG. 2 is a flowchart of a code generation method according to embodiments of the present disclosure. As shown in FIG. 2, the process includes the following steps.

Step S201, acquiring a first relational operation tree corresponding to a reference code statement and a second relational operation tree corresponding to a predicted code statement.

The predicted code statement is generated by a pre-trained code generation model according to code generation prompt information, and the reference code statement corresponds to the predicted code statement.

The reference code statement is a standard structured query language, that is, a reference SQL statement, which is constructed according to a query intention of a target object. The predicted code statement is a structured query language, that is, a predicted SQL statement, which is predicted by the code generation model according to the query intention of the target object. The reference code statement and the predicted code statement are SQL statements generated based on the same query intention.

The code generation prompt information is determined based on the query intention of the target object, that is, for different query intents, the code generation prompt information is different. Therefore, the code generation model may be guided by the code generation prompt information to output SQL statements matching the query intention.

Specifically, the code generation model may be obtained by training based on a large language model-based model architecture, may be obtained by training based on a deep learning-based model architecture, or may be obtained by training based on a neural network-based model architecture, which is not specifically limited here, as long as the code generation model is ensured to have a semantic understanding ability to perform code generation.

The first relational operation tree is a data structure that represents and executes relational algebraic operations of a reference code statement. Specifically, the reference code statement is parsed to determine components included in the reference code statement, such as a table name, a column name, a conditional expression, an aggregate function, and the like. Then, the parsed reference code statement is converted into a relational algebraic expression, and an operation tree is constructed using the relational algebraic expression. Each relational algebraic operation corresponds to a node in the operation tree, and an input required for the operation is used as a child node.

Similarly, the second relational operation tree is a data structure that represents and executes relational algebraic operations of a predicted code statement, and a construction method thereof is the same as that of the first relational operation tree, which will not be repeated here.

Step S202, performing structural matching of code statements for the first relational operation tree and the second relational operation tree in a graph matching manner to determine a structural matching result.

The graph matching manner is a matching manner based on a graph matching network (GMN). The structural matching result is used to represent a matching degree between different relational operation trees in terms of a graph structure. Specifically, the first relational operation tree and the second relational operation tree are regarded as graph structure data, and alignment of graph structures can be performed for the first relational operation tree and the second relational operation tree in the graph matching manner to perform graph-to-graph structural matching for the first relational operation tree and the second relational operation tree, so as to evaluate the similarity between the first relational operation tree and the second relational operation tree in terms of query structure and obtain the structural matching result between the first relational operation tree and the second relational operation tree in terms of the query structure.

Step S203, guiding a code generation process of the code generation model based on the structural matching result to obtain a target code matching the code generation prompt information.

The target code is a code predicted by the code generation model based on the code generation prompt information. The code generation process is a process of controlling, based on the code generation prompt information, the code generation model to generate a character token ŷₜ at each time step t, so as to optimize the quality of the generated code.

Since the structural matching result may measure the structural similarity between the reference code statement and the predicted code statement, the generation effect of the predicted code statement may be evaluated without needing to execute the predicted code statement. Specifically, the code generation task of the code generation model can be modeled as a sequential decision process and be optimized by reinforcement learning. A reward signal for the code generated by the code generation model may be provided based on the structural matching result, and the reward signal is used for reinforcement learning optimization for the code generation model to guide the code generation process of the code generation model, thereby obtaining the target code matching the code generation prompt information.

According to the code generation method provided in the present embodiment, by converting the reference code statement into the first relational operation tree, converting the predicted code statement into the second relational operation tree, and performing structural matching for the first relational operation tree and the second relational operation tree in the graph matching manner, the similarity between the reference code statement and the predicted code statement can be determined in terms of the query structure. In this way, the structural matching result between the reference code statement and the predicted code statement may be determined by directly modeling the structures of the code statements without executing the codes by the code model, thereby avoiding the dependence on execution feedback, and thus an execution-independent reward signal may be provided, which facilitates the improvement of the generalization and stability of the code generation task. Then, the code generation process of the code generation model is guided by using the structural matching result to optimize the code generation model, such that the code generation model outputs the target code that meets the code generation prompt information, thereby realizing the reinforcement learning optimization of the code generation model and ensuring the accuracy of generating the target code.

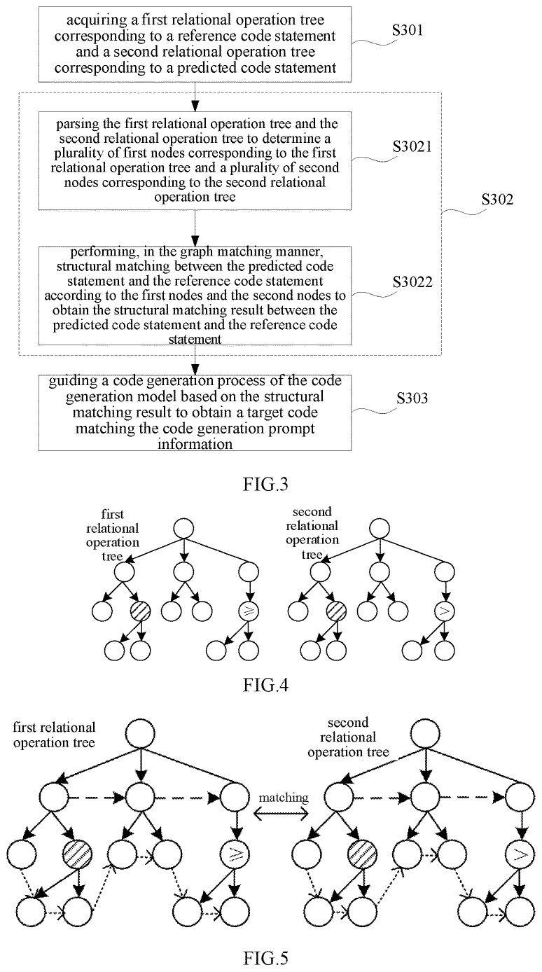

In the present embodiment, a code generation method is provided, which may be applied to an electronic device, such as a computer, a tablet computer, etc. FIG. 3 is a flowchart of a code generation method according to embodiments of the present disclosure. As shown in FIG. 3, the process includes the following steps.

Step S301, acquiring a first relational operation tree corresponding to a reference code statement and a second relational operation tree corresponding to a predicted code statement. The predicted code statement is generated by a pre-trained code generation model based on code generation prompt information, and the reference code statement corresponds to the predicted code statement. For details, please refer to the relevant description of the corresponding step of the embodiment shown above, which will not be repeated here.

Step S302, performing structural matching of code statements for the first relational operation tree and the second relational operation tree in a graph matching manner to determine a structural matching result.

Specifically, the above step S302 includes:

Step S3021, parsing the first relational operation tree and the second relational operation tree to determine a plurality of first nodes corresponding to the first relational operation tree and a plurality of second nodes corresponding to the second relational operation tree.

As described above, a relational operation tree is used to represent a query structure of a code statement. The query structure represented by the first relational operation tree may be parsed to determine a plurality of tree nodes, that is, first nodes, that constitute the first relational operation tree, where the first nodes may be root nodes or child nodes. Meanwhile, the query structure represented by the second relational operation tree may be parsed to determine a plurality of tree nodes, that is, second nodes, that constitute the second relational operation tree, where the second nodes may be root nodes or child nodes.

Step S3022, performing, in the graph matching manner, structural matching of the predicted code statement and the reference code statement according to the first nodes and the second nodes to obtain the structural matching result between the predicted code statement and the reference code statement.

The first nodes and the second nodes can be aligned in the graph matching manner, and the first nodes and the second nodes in each layer of the first relational operation tree and the second relational operation tree are compared in turn by traversing the tree structures, so as to determine a best matching node in the second relational operation tree for each first node in the first relational operation tree, where the best matching node is a second node that has the highest matching degree with the first node. The structural matching degree between the predicted code statement and the reference code statement may be determined by using the node matching results between the first nodes and the second nodes, and the structural matching result of the predicted code statement and the reference code statement can be generated.

In some optional implementations, the graph matching manner includes rule-based matching, and the rule-based matching represents measuring structural similarity for code statements (such as SQL statements) through a query structure for a relational operation tree. Correspondingly, the above step S3022 includes:

Step a1, traversing, for any one of the first nodes, a plurality of corresponding second nodes in the second relational operation tree to determine a target second node matching the first node.

Step a2, determining a precision matching parameter corresponding to the first relational operation tree and a recall matching parameter corresponding to the second relational operation tree based on a number of successful matches between the first node and the target second node.

Step a3, performing weighting based on the precision matching parameter and the recall matching parameter to determine the structural matching result.

First, let the first relational operation tree obtained by converting the reference code statement be a source tree, and let the second relational operation tree obtained by converting the predicted code statement generated by the code generation model based on the code generation prompt information be a target tree. Then, for any one of the first nodes in the first relational operation tree, the tree structures of the relational operation trees are traversed using a traversal manner such as depth-first search (DFS), breadth-first search (BFS), and hierarchical traversal, to find the best matching second node in the target tree for each first node in the source tree.

A node matching degree between the first node and the second node can be calculated as follows:

$${m}_{j} = α \times {m}_{j}^{self} + ( 1 - α ) \frac{{\sum }_{i = 0}^{N} {m}_{j}^{{child}^{i}}}{N} , α ∈ ( 0 , 1 )$$

$$where {m}_{j}^{self}$$

is a matching score of a current node itself. If the first node and the second node are the same, the score is 1, otherwise the score is 0;

$${m}_{j}^{{child}^{i}}$$

is a highest matching score of a child node, which may be calculated recursively until a leaf node; α is a balance weight coefficient, which may usually be set to 0.5~0.7, and is used to adjust the importance weight between different nodes and child nodes.

A highest node matching degree is determined according to the node matching degrees between the first node and the second nodes. The target second node matching the first node is determined by using the highest node matching degree.

The number of successful matches represents the number of successful matches between first nodes and second nodes. The precision matching parameter measures a situation that the first nodes in the first relational operation tree are successfully matched to the second nodes in the second relational operation tree. The recall matching parameter measures a situation that the second nodes in the second relational operation tree are successfully matched to the first nodes in the first relational operation tree.

The precision matching parameter can be determined by cross-comparing the first relational operation tree and the second relational operation tree, in conjunction with the proportion of nodes in the first relational operation tree that are successfully matched to the second relational operation tree. An exemplary specific determination manner is as follows:

$$Precision = \frac{\vert \{ {n}_{s} ∈ {N}_{s} \vert ∃ {n}_{t} ∈ {N}_{t} , match ( {n}_{s} , {n}_{t} ) = 1 \} \vert}{\vert {N}_{s} \vert}$$

where Precision represents the precision matching parameter; nₛ represents a first node of the first relational operation tree; Nₛ represents a node set of the first relational operation tree; nₜ represents the second node of the second relational operation tree; Nₜ represents a node set of the second relational operation tree; match (nₛ, nₜ)=1 represents a successful match between the first node and the second node; |Nₛ| represents the number of first nodes of the first relational operation tree.

The recall matching parameter is determined by cross-comparing the first relational operation tree and the second relational operation tree, in conjunction with the proportion of nodes in the second relational operation tree that are successfully matched to the first relational operation tree. An exemplary specific determination manner is as follows:

$$Recall = \frac{\vert \{ {n}_{t} ∈ {N}_{t} \vert ∃ {n}_{s} ∈ {N}_{s} , match ( {n}_{s} , {n}_{t} ) = 1 \} \vert}{\vert {N}_{t} \vert}$$

where Recall represents the recall matching parameter; nₛ represents a first node of the first relational operation tree; Nₛ represents a node set of the first relational operation tree; nₜ represents the second node of the second relational operation tree; Nₜ represents a node set of the second relational operation tree; match (nₛ, nₜ)=1 represents a successful match between the first node and the second node; |Nₜ| represents the number of second nodes of the second relational operation tree.

The precision matching parameter and the recall matching parameter can be weighted by weighted geometric mean to obtain the final structural matching degree. An exemplary specific calculation manner is as follows:

$${F}_{β} = \frac{( 1 + {β}^{2} ) \times Precision \times Recall}{{β}^{2} \times Precision + Recall}$$

where Precision represents the precision matching parameter; Recall represents the recall matching parameter; β represents a weight parameter; F_{β} represents a score of structural matching degree between the first relational operation tree and the second relational operation tree. The structural matching result between the first relational operation tree and the second relational operation tree in terms of the query structure is represented by the score of structural matching degree.

It should be noted that when evaluating the code generation model, the main concern is to ensure that the predicted codes may fully conform to the semantics of the reference code statement. In this context, a recall rate may be prioritized, which means assigning a higher β value to enhance the emphasis on matching integrity.

In a specific example, let the code generation prompt information be “which singers are over 34 years old”, and the reference code statement is constructed in conjunction with the code generation prompt information. The corresponding predicted code statement is predicted by using the code generation model. According to the first relational operation tree of the reference code statement and the second relational operation tree of the predicted code statement, the query structures of the first relational operation tree and the second relational operation tree are parsed, and node matching is performed on the first relational operation tree and the second relational operation tree. As shown in FIG. 4, the slash-filled circles indicate successfully matched nodes, while the “>=” node and the “>” node indicate matching failure nodes.

In the above implementation, the node matching between the first nodes in the first relational operation tree and the second nodes in the second relational operation tree is performed in the rule-based matching manner to implement the structural matching between the predicted code statement and the reference code statement, thereby ensuring that code statements with different writings but equivalent functions may obtain the same reward signal, avoiding the limitation of judging the generation quality of code statements depending on execution results, and improving the consistency and generalization ability of the reward signal.

In some optional implementations, the above method may further include: determining a relational similarity between the first node and the corresponding target second node based on a preset weight parameter.

The preset weight parameter is a preset weight, that is, a corresponding weight is matched for the code segment where the successfully matched node is located. Specifically, for the first node and the corresponding target second node that successfully match with each other, the code statement segment where the successfully matched node is located is determined, and a higher matching weight is assigned to the code statement segment where the successfully matched node is located, so as to highlight the influence of the core query part.

The relational similarity is used to represent the matching degree between the first node and the target second node in terms of node relationship. An exemplary specific calculation manner is as follows:

$$s = ω \times {s}_{self} + \frac{{\sum }_{i = 0}^{N} {ω}^{i} \times {s}_{child}^{i}}{N}$$

where ω is a preset weighting coefficient, that is, the preset weight parameter, which can be used to control importances of different components in the code statement. For example, in some code statement matching pairs, the weight for the JOIN relationship may be higher than the weight for the WHERE relationship; N is the number of nodes; s_{self} is the matching score of the current node;

$${s}_{child}^{i}$$

is the matching score of the child node, which can be aggregated by weighting coefficients.

In the above implementation, calculating the relational similarity between the first node and the target second node is favorable for ensuring accurate matching degree between the first node and the target second node, and provides data support for the matching between the first node and the target second node.

In some optional implementations, the graph matching manner comprises a manner that is based on a graph matching neural network algorithm. The manner that is based on the graph matching neural network algorithm enhances the relational operation trees by constructing a heterogeneous program graph, and simultaneously captures side information of the logical flow and the data flow in the relational operation trees, as shown in FIG. 5, thereby realizing richer semantic extraction. In order to improve the generalization ability, when using the graph matching neural network algorithm, global positional embedding may be introduced into the cross-attention mechanism of the network to enhance the expression ability. In addition, pre-training can be performed through graph contrastive learning, thereby improving the transferability and the adaptation ability on different data sets of the representation.

Correspondingly, the above step S3022 includes:

Step b1, acquiring, based on the graph matching neural network algorithm, first edge information corresponding to the first nodes and second edge information corresponding to the second nodes, where the first edge information is used to represent a logical flow and a data flow between the first nodes, and the second edge information is used to represent a logical flow and a data flow between the second nodes.

Step b2, performing vector mapping on each of the first nodes and its corresponding first edge information to obtain first vectors, and performing vector mapping on each of the second nodes and its corresponding second edge information to obtain second vectors.

Step b3, determining vector distances between the first vectors and the second vectors, and representing the structural matching result between the predicted code statement and the reference code statement by using the vector distances.

The first edge information represents the logical flow and the data flow between the first nodes, and the second edge information represents the logical flow and the data flow between the second nodes. According to the graph matching neural network algorithm, each of the query structures of the first relational operation tree and the second relational operation tree is represented as a heterogeneous program graph G=(V, E), where V is a node set in the relational operation tree and represents different components of the query structure of the relational operation tree; and E is an edge set of the logical flow and the data flow and represents the logical dependency between different elements in the query structure of the relational operation tree.

The query structure composed of the first nodes and the first edge information in the first relational operation tree can be mapped into vector representations by using the graph matching neural network algorithm, to obtain a plurality of first vectors corresponding to the first relational operation tree. The query structure composed of the second nodes and the second edge information in the second relational operation tree is mapped into vector representations by using the graph matching neural network algorithm, to obtain a plurality of second vectors corresponding to the second relational operation tree: h₁, h₂=GMN (G₁, G₂). The vector distances between the first vectors and the second vectors are calculated sequentially. For example, a negative Euclidean distance between a first vector and a second vector is calculated: −∥h₁−h₂∥₂.

Since the vector distance may measure vector similarity, the vector distance may be used to represent the structural matching result between the predicted code statement and the reference code statement: r_{gmn}=−∥h₁−h₂∥₂, where the value range of r_{gmn} is (−∞, 0].

In the above implementation, the vector mapping can be performed for the first relational operation tree and the second relational operation tree in the graph matching neural network algorithm-based manner to implement the structural matching between the predicted code statement and the reference code statement. In this way, by analyzing the structural characteristics between code statements instead of specific data execution results, the determination of the reward signal does not depend on a specific database, which is favorable for enhancing the generalization ability of the code generation model, enabling it to maintain stable performance in different database environments. Meanwhile, when the vector mapping is performed through the graph matching neural network algorithm, a deep semantic relationship of the code statement may be captured, which is favorable for improving scalability of the code generation model.

In some optional implementations, representing the structural matching result between the predicted code statement and the reference code statement by using the vector distances includes:

Step b31, performing transformation on the vector distances by using a preset structural matching mechanism to obtain a target structural matching manner.

Step b32, adjusting a structural matching process between the predicted code statement and the reference code statement by using the target structural matching manner to obtain the structural matching result.

The preset structural matching mechanism represents a preset structure transformation rule, and the target result matching manner is to determine a final matching manner. Specifically, in order to provide a structured and interpretable optimization signal, the vector distances may be transformed here in conjunction with an error type. An exemplary specific transformation is as follows:

$${r}_{gmn} = \{ \begin{matrix}- 1 , & syntax error \\ - 0.6 , & \begin{matrix}parsing fails , relational operation \\ tree cannot be constructed\end{matrix} \\ max ( 0 , {r}_{gmn} + 1 ) , & others\end{matrix}$$

The above target structural matching manner may ensure a good reward mechanism: if there is a syntax error, it will be severely punished (−1); if the parsing fails, it will be appropriately punished (−0.6); the query quality is gradually improved, and the reward signal may be gradually improved by positively adjusting r_gmn.

In the above implementation, adjusting the structural matching process between the predicted code statement and the reference code statement by using the target structural matching manner may not only effectively distinguish the query structures of the relational operation trees, but also provide a smooth optimization signal, so that the code generation model may be guided based on the structural matching result to generate higher-quality code statements.

Step S303, guiding a code generation process of the code generation model based on the structural matching result to obtain a target code matching the code generation prompt information. For details, please refer to the relevant description of the corresponding step of the embodiment shown above, which will not be repeated here.

In the code generation method provided in the present embodiment, the plurality of first nodes corresponding to the first relational operation tree and the plurality of second nodes corresponding to the second relational operation tree are parsed, and the structural similarity between the predicted code statement and the reference code statement is calculated in the graph matching manner, so that a reliable reward signal may be provided for subsequent optimization of the code generation model, thereby eliminating the dependence of the code generation model optimization on execution feedback, and reducing the training cost and deployment cost of the code generation model.

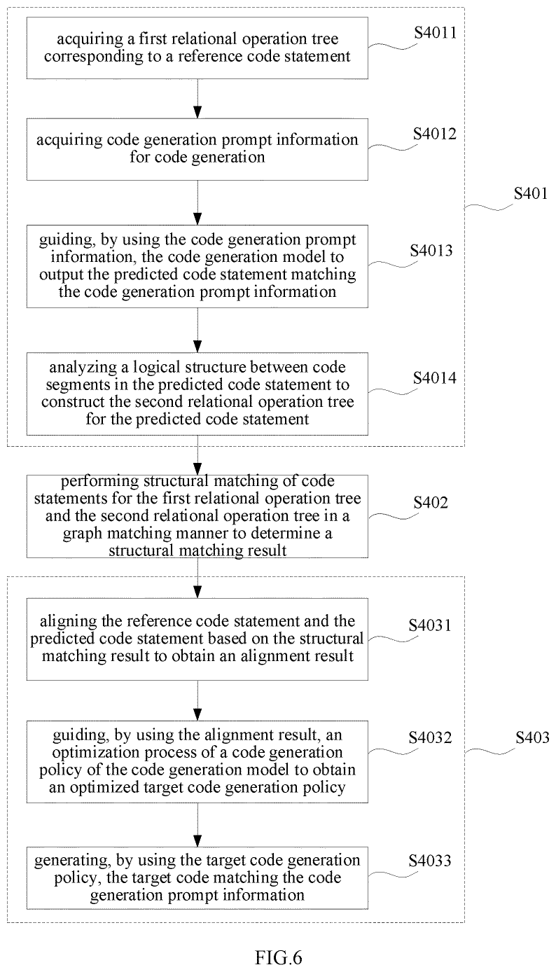

In the present embodiment, a code generation method is provided, which may be applied to an electronic device, such as a computer, a tablet computer, etc. FIG. 6 is a flowchart of a code generation method according to embodiments of the present disclosure. As shown in FIG. 6, the process includes the following steps.

Step S401, acquiring a first relational operation tree corresponding to a reference code statement and a second relational operation tree corresponding to a predicted code statement. The predicted code statement is generated by a pre-trained code generation model based on code generation prompt information, and the reference code statement corresponds to the predicted code statement.

Specifically, the above step S401 includes:

Step S4011, acquiring the first relational operation tree corresponding to the reference code statement. For details, please refer to the relevant description of the corresponding step of the embodiment shown above, which will not be repeated here.

Step S4012, acquiring code generation prompt information for code generation.

The code generation prompt information indicates prompt information used to guide the code generation process. Specifically, the code generation model has a corresponding code prompt template, the code prompt template is provided with an input position of a query intention, the query intention of the target object is read to a corresponding position in the code prompt template, and the corresponding code generation prompt information is generated through the code prompt template.

Step S4013, guiding, by using the code generation prompt information, the code generation model to output the predicted code statement matching the code generation prompt information.

The code generation process of the code generation model is guided by using the code generation prompt information. The predicted code statement is a code statement predicted by the code generation model based on the code generation prompt information. Specifically, when the code generation prompt information is acquired, the code generation model is controlled to guide a prediction generation task of the code statement according to the code generation prompt information, a plurality of code segments are generated according to the prediction generation task, and the plurality of code segments are combined into the predicted code statement matching the code generation prompt information.

Step S4014, analyzing a logical structure between code segments in the predicted code statement to construct the second relational operation tree for the predicted code statement.

The predicted code statement is composed of a plurality of code segments, and the code segments are combined together through a logical component (such as a conditional judgment component, an aggregate function component, etc.). A logical structure between the code segments in the predicted code statement is analyzed to determine the query structure formed by the code segments of the predicted code statement, and a relational operation tree formed by the predicted code statement, that is, the second relational operation tree, is constructed based on the logical relationship between the query structures.

Step S402, performing structural matching of code statements for the first relational operation tree and the second relational operation tree in a graph matching manner to determine a structural matching result. For details, please refer to the relevant description of the corresponding step of the embodiment shown above, which will not be repeated here.

Step S403, guiding a code generation process of the code generation model based on the structural matching result to obtain a target code matching the code generation prompt information.

Specifically, the above step S403 includes:

Step S4031, aligning the reference code statement and the predicted code statement based on the structural matching result to obtain an alignment result.

The reward signal for the code generation model in the code generation process may be determined based on the structural matching result. The reward signal is introduced to determine a code alignment standard for the reference code statement and the predicted code statement in terms of syntactic correctness, functional correctness and query intention preference. The reference code statement and the predicted code statement are aligned and adjusted line by line according to the code alignment standard to obtain the corresponding statement alignment result.

Step S4032, guiding, by using the alignment result, an optimization process of a code generation policy of the code generation model to obtain an optimized target code generation policy.

The target code generation policy is an optimal policy for code generation to maximize expected returns. Specifically, the code generation process of the code generation model can be expressed as a decision process of a code generation task. Given the code generation prompt information, the code generation model samples a code sequence ŷ=(ŷ₁, . . . , ŷₜ) from the code generation policy π_{θ}. The quality of the generated code sequence may be measured by a reward function r(x, ŷ). In order to optimize the code generation policy while maintaining stability, a KL regularization objective may be used here:

$$J ( θ ) = {𝔼}_{( x , \hat{y} ) ∼ {D}_{{π}_{θ}}} [ r ( x , \hat{y} ) - β {D}_{KL} ( {π}_{θ} ( \cdot \vert x ) \vert \vert {π}_{ref} ( \cdot \vert x ) ) ]$$

where D_{πθ} represents a distribution sampled from the code generation policy π_{θ}, and a constraint term is used to prevent the policy from deviating from the known supervised fine-tuning policy π_{ref}.

Under a general nonparametric policy class, an optimal solution of the objective has the following form:

$${π}^{*} ( \hat{y} \vert x ) = \frac{1}{Z ( x )} {π}_{ref} ( \hat{y} \vert x ) exp ( \frac{1}{β} r ( x , \hat{y} ) )$$

$$where Z ( x ) = {\sum }_{\hat{y}} {π}_{ref} ( \hat{y} \vert x ) exp ( \frac{1}{β} r ( x , \hat{y} ) )$$

is a normalization constant, indicating that an optimal target code generation policy may be acquired by exponentially tilting the code generation policy π_{θ} based on the reward. Therefore, it is necessary to design a well-calibrated reward function r(x, ŷ), through which a generation behavior required by the code generation model, such as syntactic correctness and functional effectiveness, may be captured.

In a policy gradient optimization, the following objective is maximized:

$${𝔼}_{( x , \hat{y} ) ∼ {D}_{{π}_{θ}}} {\sum }_{t = 1}^{T} {A}^{{π}_{θ}} ( {\hat{y}}_{t} \vert {\hat{y}}_{< t} , x ) log {π}_{θ} ( {\hat{y}}_{t} \vert {\hat{y}}_{< t} , x )$$

where an advantage function A^{πθ} is used to measure the quality of the currently output code field relative to an average performance of the code generation policy. In order to prevent a new code generation policy π_{θ} from excessively deviating from the old code generation policy π_{θold}, a reinforcement learning algorithm PPO may be used here, and the training is stabilized by clipping a ratio between the old and new policies. A surrogate objective used in PPO is defined as:

$${𝔼}_{\hat{y} ∼ {π}_{{θ}_{old}}} [ {\sum }_{t = 1}^{T} min ( {r}_{t} ( θ ) {\hat{A}}_{y}^{{π}_{θ}} , clip ( {r}_{t} ( θ ) , 1 - ϵ , 1 + ϵ ) {\hat{A}}_{t}^{{π}_{θ}} ) ]$$

where rₜ(θ) is used to measure the change amplitude between the old and new code generation policies; the clipping parameter ϵ is used to limit an update amplitude of the code generation policy to prevent unstable training.

In order to more stably estimate an advantage function, a generalized advantage estimation (GAE) may be used here:

$${\hat{A}}_{t}^{{π}_{θ}} = {\sum }_{l = 0}^{T - t - 1} {( γλ )}^{l} {δ}_{t + l}$$

where a temporal difference error δₜ is calculated as follows:

δₜ=R(ŷ_{<t′}x)−\hat{V}^{π}^{_{θ}}(ŷ_{<t′}x)+γ·\hat{V}^{π}^{_{θ}}(ŷ_{<t+1′}x)

where the hyperparameter λ∈[0, 1] is used to control a trade-off between bias and variance.

Step S4033, generating, by using the target code generation policy, the target code matching the code generation prompt information.

By guiding the code generation process of the code generation model according to the code generation prompt information, the code generation model may perform code generation according to the target code generation policy to output the target code that conforms to the code generation prompt information.

According to the code generation method provided in an embodiment of the present disclosure, the code generation model is guided by using the code generation prompt information to output the corresponding predicted code statement. The logical connection relationship between the code segments in the predicted code statement is determined by analyzing the logical structure between the code segments in the predicted code statement, so as to construct the corresponding relational operation tree according to the logical connection relationship, thereby realizing the conversion of the predicted code statement to the relational operation tree, so as to facilitate the subsequent structural matching of the code statements based on the relational operation tree. The reference code statement and the predicted code statement are aligned, and the alignment result can be used to optimize the code generation policy to obtain the optimal target code generation policy. Thus, the target code generation policy is used for code generation, thereby realizing the optimization of the code generation policy by using the structure of the code statement, avoiding the dependence of the code generation optimization on the execution feedback, and improving the quality of code generation.

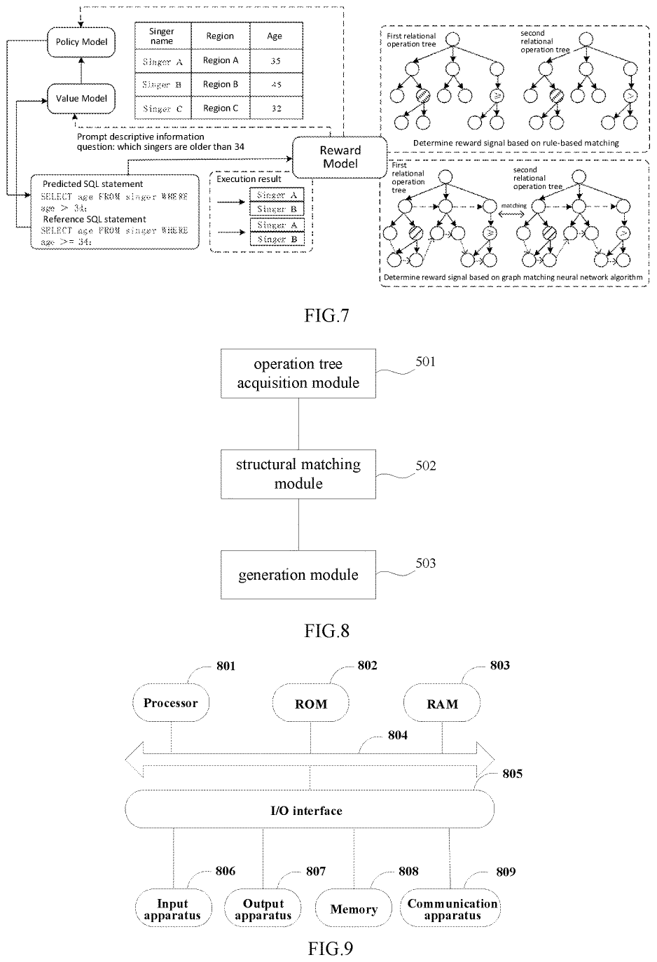

As a specific application embodiment of embodiments of the present disclosure, as shown in FIG. 7, the code generation model includes a policy model, a value model, and a reward model. The policy model in the code generation model may generate a structured query language SQL matching code generation prompt information in a given natural language based on the code generation prompt information. Then, a corresponding reward is obtained for the action of generating the code character token ŷₜ at each time step t, to guide and control the update of the code generation policy. The reward score in the reward model may be composed of different elements: (a) an execution score based on a compiler signal; (b) a structural matching score based on the first relational operation tree and the second relational operation tree, and (c) a graph matching network score. The reward score may be determined by parsing the query structure of the SQL statement through the relational operation tree and calculating the structural matching degree. The reward score may also be calculated by enhancing the relational operation tree (ROT) through constructing a heterogeneous program graph via a graph matching neural network algorithm (FuncEvalGMN), wherein the FuncEvalGMN maps the SQL statement into a vector representation through the graph matching network, and then by calculating a negative Euclidean distance between the vectors. Then, the value model may estimate the value according to the obtained reward, and the code generation model will be optimized using PPO to output a high-quality target SQL statement.

By introducing the reward model based on the graph matching algorithm, an optimization method that does not require execution feedback can be provided for the code generation task of the code generation model, which may greatly reduce the dependence on unit tests and improve the training efficiency and scalability. Since the reinforcement learning code generation method depends on execution feedback, that is, by running the codes and providing rewards based on unit test results, however, the cost of constructing high-quality unit tests is extremely high, especially the text-to-SQL task requires the construction of a complete test database, which greatly limits the scalability of the method. Here, the structural matching degree in structures between the reference SQL statement and the predicted SQL statement is evaluated by constructing the relational operation tree and the graph matching manner, thereby avoiding the dependence on execution feedback, and making the method more feasible in large-scale industrial applications.

Compared with the reward model predicted based on LLM, the reward signal generated by the reward model in the code generation model here is more stable, highly consistent with the actual execution result, reduces the instability caused by the LLM scoring deviation, and significantly reduces the calculation cost, and may show higher efficiency in the training and inference stages. Specifically, the code generation model uses relational node matching (RelPM) and a graph matching neural network algorithm to perform structural matching of SQL statements, ensuring that SQL statements with different writings but equivalent functions receive the same reward, avoiding the limitation of judging the quality of SQL statements by only relying on execution results, and improving the consistency and generalization ability of the reward signals.

In addition, compared with the method based on execution feedback, the code generation model here has stronger transfer ability in cross-domain SQL task generation, especially 1.26% higher than the best execution feedback method on the BIRD dataset, showing stronger cross-domain adaptation ability. Meanwhile, this method has extremely low occupation of computing resources, reducing 12.8 times compared with the LLM scoring method, and the inference speed is increased by 12.6 times, making large-scale application more feasible.

In addition, the code generation model here also has good compatibility, may be seamlessly integrated into the reinforcement learning optimization framework, is compatible with PPO (Proximal Policy Optimization), and provides a stable and interpretable reward signal, thereby avoiding the model deviation problem caused by unstable feedback in the training process.

Therefore, the code generation model may solve the key problem in reinforcement learning optimization code generation with the characteristics of low cost, high stability and high generalization ability, is applicable to the code generation task of text-to-SQL, and may provide a new direction for code generation reward modeling based on the graph structure.

In the present embodiment, a code generation apparatus is further provided, and the apparatus is used to implement the above embodiments and preferred implementations, which will not be repeated here. As used below, the term “module” may implement a combination of software and/or hardware for a predetermined function. Although the apparatus described in the following embodiments is preferably implemented in software, implementation in hardware, or a combination of software and hardware is also possible and contemplated.

The present embodiment provides a code generation apparatus, as shown in FIG. 8, including:
an operation tree acquisition module 501, configured to acquire a first relational operation tree corresponding to a reference code statement and a second relational operation tree corresponding to a predicted code statement, where the predicted code statement is generated by a pre-trained code generation model based on code generation prompt information, and the reference code statement corresponds to the predicted code statement;
a structural matching module 502, configured to perform structural matching of code statements for the first relational operation tree and the second relational operation tree in a graph matching manner to determine a structural matching result; and
a generation module 503, configured to guide a code generation process of the code generation model based on the structural matching result to obtain a target code matching the code generation prompt information.

In some optional implementations, the structural matching module 502 includes:
a node parsing unit, configured to parse the first relational operation tree and the second relational operation tree to determine a plurality of first nodes corresponding to the first relational operation tree and a plurality of second nodes corresponding to the second relational operation tree; and
a structural matching unit, configured to perform, in a graph matching manner, structural matching of the predicted code statement and the reference code statement according to the first nodes and the second nodes to obtain the structural matching result between the predicted code statement and the reference code statement.

In some optional implementations, the graph matching manner includes rule-based matching, and accordingly, the structural matching unit includes:
a node traversal subunit, configured to traverse, for any one of the first nodes, the plurality of second nodes corresponding to the second relational operation tree to determine a target second node matching the first node;
a matching determination subunit, configured to determine a precision matching parameter corresponding to the first relational operation tree and a recall matching parameter corresponding to the second relational operation tree based on a number of successful matches between the first node and the target second node; and
a weighting subunit, configured to perform weighting based on the precision matching parameter and the recall matching parameter to determine the structural matching result.

In some optional implementations, the above structural matching unit may further include:
a relational similarity determination subunit, configured to determine relational similarity between the first node and the corresponding target second node based on a preset weight parameter.

In some optional implementations, the graph matching manner includes a manner based on a graph matching neural network algorithm, and accordingly, the structural matching unit may further include:
an edge information acquisition subunit, configured to acquire, based on the graph matching neural network algorithm, first edge information corresponding to the first nodes and second edge information corresponding to the second nodes, where the first edge information is used to represent a logical flow and a data flow between the first nodes, and the second edge information is used to represent a logical flow and a data flow between the second nodes;
a mapping subunit, configured to perform vector mapping on the first nodes and the corresponding first edge information to obtain first vectors, and perform vector mapping on the second nodes and the corresponding second edge information to obtain second vectors; and
a vector distance determination subunit, configured to determine vector distances between the first vectors and the second vectors, and represent the structural matching result between the predicted code statement and the reference code statement by using the vector distances.

In some optional implementations, the vector distance determination subunit is further configured to perform transformation on the vector distances by using a preset structural matching mechanism to obtain a target structural matching manner; and adjust a structural matching process between the predicted code statement and the reference code statement by using the target structural matching manner to obtain the structural matching result.

In some optional implementations, the operation tree acquisition module 501 includes:
a prompt information acquisition unit, configured to acquire code generation prompt information for code generation;
a prediction generation unit, configured to guide, by using the code generation prompt information, the code generation model to output the predicted code statement matching the code generation prompt information; and
a logical analysis unit, configured to analyze a logical structure between code segments in the predicted code statement to construct the second relational operation tree for the predicted code statement.

In some optional implementations, the generation module 503 includes:
an alignment unit, configured to align the reference code statement and the predicted code statement based on the structural matching result to obtain an alignment result;
a policy optimization unit, configured to guide, by using the alignment result, an optimization process of a code generation policy of the code generation model to obtain an optimized target code generation policy; and
a code generation unit, configured to generate, by using the target code generation policy, the target code matching the code generation prompt information.

Further functional descriptions of the above modules and units are the same as the corresponding embodiments discussed above, and will not be repeated here.

The code generation apparatus provided in embodiments of the present disclosure may perform the code generation method provided in any embodiment of the present disclosure, and has corresponding functional modules for performing the method and achieving the beneficial effects. The reference code statement is converted into the first relational operation tree, and the predicted code statement is converted into the second relational operation tree. The structural matching is performed on the first relational operation tree and the second relational operation tree in the graph matching manner to determine the similarity between the reference code statement and the predicted code statement in terms of the query structure. In this way, the structural matching result between the reference code statement and the predicted code statement may be determined by directly modeling the structures of the code statements without executing the codes by code models, thereby avoiding the dependence on execution feedback, and thus an execution-independent reward signal may be provided, which facilitates the improvement of the generalization and stability of the code generation task. Then, the code generation process of the code generation model can be guided by using the structural matching result to optimize the code generation model, such that the code generation model outputs the target code that conforms to the code generation prompt information, thereby realizing the reinforcement learning optimization of the code generation model and ensuring the accuracy of generating the target code.

FIG. 9 is a schematic structural diagram of an electronic device provided in embodiments of the present disclosure.

Reference is made specifically to FIG. 9 below, which illustrates a schematic structural diagram of an electronic device suitable for implementing the embodiments of the present disclosure. The electronic device may include a processor (such as a central processing unit, a graphics processor, etc.) 801, which may perform various appropriate actions and processes according to a program stored in a read-only memory (ROM) 802 or a program loaded from a memory 808 into a random-access memory (RAM) 803. In the RAM 803, various programs and data required for the operation of the electronic device are also stored. The processor 801, the ROM 802, and the RAM 803 are connected to each other through a bus 804. An input/output (I/O) interface 805 is also connected to the bus 804.

Usually, the following apparatuses may be connected to the I/O interface 805: an input apparatus 806 including, for example, a touch screen, a touchpad, a keyboard, a mouse, a camera, a microphone, an accelerometer, a gyroscope, etc.; an output apparatus 807 including, for example, a liquid crystal display (LCD), a speaker, a vibrator, etc.; a memory 808 including, for example, a magnetic tape, a hard disk, etc.; and a communication apparatus 809. The communication apparatus 809 may allow the electronic device to perform wireless or wired communication with other devices to exchange data. Although FIG. 9 shows an electronic device with various apparatuses, it should be understood that it is not required to implement or have all the apparatuses shown, and more or fewer apparatuses may be implemented or provided alternatively.

In particular, according to the embodiments of the present disclosure, the process described above with reference to the flowchart may be implemented as a computer software program. For example, the embodiments of the present disclosure include a computer program product, which includes a computer program carried on a non-transitory computer-readable medium, where the computer program includes program codes for performing the method shown in the flowchart. In such an embodiment, the computer program may be downloaded and installed from a network through the communication apparatus 809, or installed from the memory 808, or installed from the ROM 802. When the computer program is executed by the processor 801, the above functions defined in the code generation method of the embodiments of the present disclosure are executed.

The electronic device shown in FIG. 9 is only an example, and should not impose any limitation on the functions and the range of use of the embodiments of the present disclosure.

The embodiments of the present disclosure further provide a computer-readable storage medium, and the method according to the embodiments of the present disclosure may be implemented in hardware, firmware, or as computer codes that may be recorded on a storage medium or originally stored in a remote storage medium or a non-transitory machine-readable storage medium downloaded through a network and to be stored in a local storage medium, so that the method described herein may be stored on such software on a storage medium using a general-purpose computer, a dedicated processor, or programmable or dedicated hardware. The storage medium may be a magnetic disk, an optical disk, a read-only memory, a random-access memory, a flash memory, a hard disk, or a solid-state disk, etc. Further, the storage medium may also include a combination of the above types of memories. It may be understood that the computer, the processor, the microprocessor controller or the programmable hardware includes a storage component that may store or receive software or computer codes, and when the software or computer codes are accessed and executed by the computer, the processor or the hardware, the code generation method shown in the above embodiments is implemented.

A part of the present disclosure may be applied as a computer program product, such as computer program instructions, which, when executed by a computer, may invoke or provide the method and/or technical solution according to the present disclosure through the operation of the computer. Those skilled in the art should understand that the form of the computer program instructions in the computer-readable medium includes, but is not limited to, a source file, an executable file, an installation package file, etc. Accordingly, the manner in which the computer program instructions are executed by the computer includes, but is not limited to, the computer directly executes the instructions, or the computer compiles the instructions and then executes the corresponding compiled program, or the computer reads and executes the instructions, or the computer reads and installs the instructions and then executes the corresponding installed program. Here, the computer-readable medium may be any available computer-readable storage medium or communication medium accessible by the computer.

Although the embodiments of the present disclosure are described in conjunction with the drawings, those skilled in the art may make various modifications and variations without departing from the spirit and scope of the present disclosure, and such modifications and variations fall within the scope defined by the appended claims.

What is claimed is:

1. A code generation method, comprising:
acquiring a first relational operation tree corresponding to a reference code statement and a second relational operation tree corresponding to a predicted code statement, the predicted code statement being generated by a pre-trained code generation model based on code generation prompt information, the reference code statement corresponding to the predicted code statement;
performing structural matching of code statements for the first relational operation tree and the second relational operation tree in a graph matching manner to determine a structural matching result; and
guiding a code generation process of the code generation model based on the structural matching result to obtain a target code matching the code generation prompt information.

2. The method of claim 1, wherein the performing structural matching of code statements for the first relational operation tree and the second relational operation tree in the graph matching manner to determine the structural matching result, comprises:
parsing the first relational operation tree and the second relational operation tree to determine a plurality of first nodes corresponding to the first relational operation tree and a plurality of second nodes corresponding to the second relational operation tree; and
performing, in the graph matching manner, structural matching between the predicted code statement and the reference code statement according to the first nodes and the second nodes to obtain the structural matching result between the predicted code statement and the reference code statement.

3. The method of claim 2, wherein the graph matching manner comprises rule-based matching, and the performing, in the graph matching manner, structural matching between the predicted code statement and the reference code statement according to the first nodes and the second nodes to obtain the structural matching result between the predicted code statement and the reference code statement, comprises:
traversing, for any one of the first nodes, the plurality of second nodes corresponding to the second relational operation tree to determine a target second node matching the first node;
determining a precision matching parameter corresponding to the first relational operation tree and a recall matching parameter corresponding to the second relational operation tree, based on a number of successful matches between the first node and the target second node; and
performing weighting based on the precision matching parameter and the recall matching parameter to determine the structural matching result.

4. The method of claim 3, further comprising:
determining relational similarity between the first node and the corresponding target second node based on a preset weight parameter.

5. The method of claim 2, wherein the graph matching manner comprises a manner based on graph matching neural network algorithm, and the performing, in the graph matching manner, structural matching between the predicted code statement and the reference code statement according to the first nodes and the second nodes to obtain the structural matching result between the predicted code statement and the reference code statement, comprises:
acquiring, based on the graph matching neural network algorithm, first edge information corresponding to the first nodes and second edge information corresponding to the second nodes, the first edge information being configured to represent a logical flow and a data flow among the first nodes, the second edge information being configured to represent a logical flow and a data flow among the second nodes;
performing vector mapping on each of the first nodes and the corresponding first edge information to obtain first vectors, and performing vector mapping on each of the second nodes and the corresponding second edge information to obtain second vectors; and
determining vector distances between the first vectors and the second vectors, and representing the structural matching result between the predicted code statement and the reference code statement by using the vector distances.

6. The method of claim 5, wherein the representing the structural matching result between the predicted code statement and the reference code statement by using the vector distances comprises:
performing transformation on the vector distances by using a preset structural matching mechanism to obtain a target structural matching manner; and
adjusting a structural matching process between the predicted code statement and the reference code statement by using the target structural matching manner to obtain the structural matching result.

7. The method of claim 1, wherein the acquiring the second relational operation tree corresponding to the predicted code statement comprises:
acquiring code generation prompt information for code generation;
guiding, by using the code generation prompt information, the code generation model to output the predicted code statement matching the code generation prompt information; and
analyzing a logical structure among code segments in the predicted code statement to construct the second relational operation tree for the predicted code statement.

8. The method of claim 1, wherein the guiding the code generation process of the code generation model based on the structural matching result to obtain the target code matching the code generation prompt information, comprises:
aligning the reference code statement and the predicted code statement based on the structural matching result to obtain an alignment result;
guiding, by using the alignment result, an optimization process of a code generation policy of the code generation model to obtain an optimized target code generation policy; and
generating, by using the target code generation policy, the target code matching the code generation prompt information.

9. An electronic device, comprising:
a memory and a processor, the memory and the processor being communicatively connected to each other, the memory storing computer instructions, the processor executing the computer instructions to perform:
acquiring a first relational operation tree corresponding to a reference code statement and a second relational operation tree corresponding to a predicted code statement, the predicted code statement being generated by a pre-trained code generation model based on code generation prompt information, the reference code statement corresponding to the predicted code statement;
performing structural matching of code statements for the first relational operation tree and the second relational operation tree in a graph matching manner to determine a structural matching result; and
guiding a code generation process of the code generation model based on the structural matching result to obtain a target code matching the code generation prompt information.

10. The electronic device of claim 9, wherein the performing structural matching of code statements for the first relational operation tree and the second relational operation tree in the graph matching manner to determine the structural matching result, comprises:
parsing the first relational operation tree and the second relational operation tree to determine a plurality of first nodes corresponding to the first relational operation tree and a plurality of second nodes corresponding to the second relational operation tree; and
performing, in the graph matching manner, structural matching between the predicted code statement and the reference code statement according to the first nodes and the second nodes to obtain the structural matching result between the predicted code statement and the reference code statement.

11. The electronic device of claim 10, wherein the graph matching manner comprises rule-based matching, and the performing, in the graph matching manner, structural matching between the predicted code statement and the reference code statement according to the first nodes and the second nodes to obtain the structural matching result between the predicted code statement and the reference code statement, comprises:
traversing, for any one of the first nodes, the plurality of second nodes corresponding to the second relational operation tree to determine a target second node matching the first node;
determining a precision matching parameter corresponding to the first relational operation tree and a recall matching parameter corresponding to the second relational operation tree, based on a number of successful matches between the first node and the target second node; and
performing weighting based on the precision matching parameter and the recall matching parameter to determine the structural matching result, or
wherein the graph matching manner comprises a manner based on graph matching neural network algorithm, and the performing, in the graph matching manner, structural matching between the predicted code statement and the reference code statement according to the first nodes and the second nodes to obtain the structural matching result between the predicted code statement and the reference code statement, comprises:
acquiring, based on the graph matching neural network algorithm, first edge information corresponding to the first nodes and second edge information corresponding to the second nodes, the first edge information being configured to represent a logical flow and a data flow among the first nodes, the second edge information being configured to represent a logical flow and a data flow among the second nodes;
performing vector mapping on each of the first nodes and the corresponding first edge information to obtain first vectors, and performing vector mapping on each of the second nodes and the corresponding second edge information to obtain second vectors; and
determining vector distances between the first vectors and the second vectors, and representing the structural matching result between the predicted code statement and the reference code statement by using the vector distances.

12. The electronic device of claim 11, wherein the representing the structural matching result between the predicted code statement and the reference code statement by using the vector distances comprises:
performing transformation on the vector distances by using a preset structural matching mechanism to obtain a target structural matching manner; and
adjusting a structural matching process between the predicted code statement and the reference code statement by using the target structural matching manner to obtain the structural matching result.

13. The electronic device of claim 9, wherein the acquiring the second relational operation tree corresponding to the predicted code statement comprises:
acquiring code generation prompt information for code generation;
guiding, by using the code generation prompt information, the code generation model to output the predicted code statement matching the code generation prompt information; and
analyzing a logical structure among code segments in the predicted code statement to construct the second relational operation tree for the predicted code statement.

14. The electronic device of claim 9, wherein the guiding the code generation process of the code generation model based on the structural matching result to obtain the target code matching the code generation prompt information, comprises:
aligning the reference code statement and the predicted code statement based on the structural matching result to obtain an alignment result;
guiding, by using the alignment result, an optimization process of a code generation policy of the code generation model to obtain an optimized target code generation policy; and
generating, by using the target code generation policy, the target code matching the code generation prompt information.

15. A non-transitory computer-readable storage medium having computer instructions stored thereon, wherein the computer instructions are configured to, when executed by a computer, cause the computer to perform:
acquiring a first relational operation tree corresponding to a reference code statement and a second relational operation tree corresponding to a predicted code statement, the predicted code statement being generated by a pre-trained code generation model based on code generation prompt information, the reference code statement corresponding to the predicted code statement;
performing structural matching of code statements for the first relational operation tree and the second relational operation tree in a graph matching manner to determine a structural matching result; and
guiding a code generation process of the code generation model based on the structural matching result to obtain a target code matching the code generation prompt information.

16. The non-transitory computer-readable storage medium of claim 15, wherein the performing structural matching of code statements for the first relational operation tree and the second relational operation tree in the graph matching manner to determine the structural matching result, comprises:
parsing the first relational operation tree and the second relational operation tree to determine a plurality of first nodes corresponding to the first relational operation tree and a plurality of second nodes corresponding to the second relational operation tree; and
performing, in the graph matching manner, structural matching between the predicted code statement and the reference code statement according to the first nodes and the second nodes to obtain the structural matching result between the predicted code statement and the reference code statement.

17. The non-transitory computer-readable storage medium of claim 16, wherein the graph matching manner comprises rule-based matching, and the performing, in the graph matching manner, structural matching between the predicted code statement and the reference code statement according to the first nodes and the second nodes to obtain the structural matching result between the predicted code statement and the reference code statement, comprises:
traversing, for any one of the first nodes, the plurality of second nodes corresponding to the second relational operation tree to determine a target second node matching the first node;
determining a precision matching parameter corresponding to the first relational operation tree and a recall matching parameter corresponding to the second relational operation tree, based on a number of successful matches between the first node and the target second node; and
performing weighting based on the precision matching parameter and the recall matching parameter to determine the structural matching result, or
wherein the graph matching manner comprises a manner based on graph matching neural network algorithm, and the performing, in the graph matching manner, structural matching between the predicted code statement and the reference code statement according to the first nodes and the second nodes to obtain the structural matching result between the predicted code statement and the reference code statement, comprises:
acquiring, based on the graph matching neural network algorithm, first edge information corresponding to the first nodes and second edge information corresponding to the second nodes, the first edge information being configured to represent a logical flow and a data flow among the first nodes, the second edge information being configured to represent a logical flow and a data flow among the second nodes;
performing vector mapping on each of the first nodes and the corresponding first edge information to obtain first vectors, and performing vector mapping on each of the second nodes and the corresponding second edge information to obtain second vectors; and
determining vector distances between the first vectors and the second vectors, and representing the structural matching result between the predicted code statement and the reference code statement by using the vector distances.

18. The non-transitory computer-readable storage medium of claim 17, wherein the representing the structural matching result between the predicted code statement and the reference code statement by using the vector distances comprises:
performing transformation on the vector distances by using a preset structural matching mechanism to obtain a target structural matching manner; and
adjusting a structural matching process between the predicted code statement and the reference code statement by using the target structural matching manner to obtain the structural matching result.

19. The non-transitory computer-readable storage medium of claim 15, wherein the acquiring the second relational operation tree corresponding to the predicted code statement comprises:
acquiring code generation prompt information for code generation;
guiding, by using the code generation prompt information, the code generation model to output the predicted code statement matching the code generation prompt information; and
analyzing a logical structure among code segments in the predicted code statement to construct the second relational operation tree for the predicted code statement.

20. The non-transitory computer-readable storage medium of claim 15, wherein the guiding the code generation process of the code generation model based on the structural matching result to obtain the target code matching the code generation prompt information, comprises:
aligning the reference code statement and the predicted code statement based on the structural matching result to obtain an alignment result;
guiding, by using the alignment result, an optimization process of a code generation policy of the code generation model to obtain an optimized target code generation policy; and
generating, by using the target code generation policy, the target code matching the code generation prompt information.
